(19) United States
(12) Patent Application Publication
(10) Pub. No.: US 2016/0354951 A1
(43) Pub. Date: Dec. 8, 2016

(54) Method for Producing a Fiber Preform for a Fiber Composite Component

(71) Applicant: Bayerische Motoren Werke Aktiengesellschaft, Muenchen (DE)

(72) Inventors: Horst MAI, Furth (DE); Eva HONICKEL, Landshut (DE); Mirko SCHADE, Landshut (DE); Maximilian MARQUART, Muenchen (DE)

(21) Appl. No.: 15/240,754

(22) Filed: Aug. 18, 2016

Related U.S. Application Data
(63) Continuation of application No. PCT/EP2015/054558, filed on Mar. 5, 2015.

(30) Foreign Application Priority Data
Mar. 25, 2014 (DE) 10 2014 205 479.6

(51) Int. Cl. B29B 11/16; B29C 70/54

(52) U.S. Cl. CPC B29B 11/16; B29C 70/543; B29C 70/545; B29K 2105/0881

(57) ABSTRACT

A method is provided for producing a fiber preform for a fiber composite component, in which method a fiber arrangement is provided on a support material and the support material is held, during a forming process, by a clamping device. The method provides at least one blank made of a fiber material; orients the blank according to the direction of loading of the blank in the fiber composite component by means of an automated manipulation device; fastens the blank to the support material; and provides the support material having the fastened blank for a subsequent process.

### CROSS REFERENCE TO RELATED APPLICATIONS

This application is a continuation of PCT international Application No. PCT/EP20151054558, filed Mar. 5, 2015, which claims priority under 35 U.S.C. §119 from German Patent Application No. 10 2014 205 479.6, filed Mar. 25, 2014, the entire disclosures of which are herein expressly incorporated by reference.

### BACKGROUND AND SUMMARY OF THE INVENTION

The present invention relates to a method for producing a fiber preform for a fibercomposite component, wherein a fiber arrangement is placed on a support material and the support material is held by a clamping device during a forming process.

For the industrialized manufacturing of fiber composite components, it is necessary to form a multilayer layer construction in a forming operation. For preparing the forming operation, a two-dimensional fiber preform has to be created that is composed of several individual layers. For producing the fiber preform, to date layers of fiber composites have been assembled to a stack or layer construction and have been chemically or mechanically fixed in a punctiform manner. The stack is then processed by cutting through all individual layers at once to obtain the preform to be formed. Finally, the fiber composite component is produced during a forming operation with the addition of heat.

So that the preform forms during the forming operation in the cavity of the tool in a controlled manner with a defined change of the fiber orientations, without the formation of undesired wrinkles or faults, the preform has to be held by way of a tensioning frame or blank holder. The frame or holder permits a controlled relative movement and continued flowing of areas of the individual layers with respect to one another, but prevents an uncontrolled shifting of the individual layers with respect to one another. For this purpose, up to now, the starting material of the fiber composite component had been cut in a large-area fashion, so that sufficient material was available for the fixing of the material in the tensioning frame. Naturally, in the case of this approach, the consumption of fiber material is high, which fiber material has to he added just so that sufficient material will be available for the clamping into the tensioning frame.

German Patent document DE 10 2010 023 044 A1 discloses a method for producing a fiber preform for a fiber composite component, wherein a fiber bundle of carbon fibers is deposited by way of a laying device along a predefined three-dimensional curve on a support material and is fixed to the latter by thermal activation of a thermoplastic binder material.

Furthermore, German Patent document DE 10 2004 060 647 B4 discloses a device for fixing a fiber arrangement on a conveyor belt by means of a sewing station. The fiber arrangement can be placed on the basic fiber structure by use of a laying device.

In order to reduce the consumption of starting material for the fiber composite component, it has been known as a result of the unpublished German Patent Application DE 10 2013 204 270.9, originating from the Applicant here, to place the fiber arrangement, that is to be formed, in a covering, which consists of a flexible material and facilitates the handling of a multilayer fiber arrangement. In this case, the covering has larger dimensions than the fiber arrangement and can be held by a tensioning frame. It is also contemplated to connect the covering, at least in sections, in a frictional and/or material-bonding manner, in order to permit a transmission of force between the covering and the fiber arrangement.

Based on the above, it is an object of the present invention to provide a method by which the consumption of fiber starting material can be reduced; the costs of the production of the fiber composite component can be reduced; and a fiber composite component can be produced that has a complex outer contour and a complex integrated construction.

These and other objects are achieved according to the invention by a method of producing a fiber preform for a fiber composite component, wherein a fiber arrangement is placed on a support material and, during a forming operation, the support material is held by a clamping device. The method includes the acts of:

providing at least one blank from a fiber material;

aligning the blank corresponding to the direction of the loading of the blank in the fiber composite component by way of an automated handling device;

fixing the blank on the support material;

providing of the support material with the fixed blank for a subsequent process.

In contrast to the known method, in the case of the method according to the invention, first at least one blank from a fiber material is provided, and the at least one blank is arranged corresponding to the direction of the loading of the blank in the fiber composite component by way of an automated handling device on the support material. The operation of the alignment may be a positioning and rotating of the al least one blank by the automated handling device which, for example, by use of a sensor device, can detect an aligned fiber course in the blank and can then position the blank according to the load path on the support material.

For a three-dimensional fiber composite component, differently shaped blanks made of different starting fiber materials may be arranged on the support material in this mariner by use of the automated handling device, thus, for example, along the longitudinal and transverse direction of the fiber preform in different layer thicknesses and different layer orientations of the individual blanks, for optimizing the strength and stiffness of the finished fiber composite component.

Corresponding to the multidimensional distribution of stress prevailing in the fiber composite component during future use, blanks made of different fiber base materials and fiber base orientations can be applied in layers to the support material by means of the automated handling device and to the at least one blank already arranged on the support material. In this case, the area consumption of fiber starting material can clearly be reduced and can be adapted to the required dimensions of the blank in the finished fiber composite component. Thereby, clearly less starting material of fiber base material is required than is necessary in the case of the known method, in which a stack with mutually stacked layers of the same sizes is provided on the starting fiber materials, through all of which then a blanking operation will take place all at once.

In a next step of the method according to the invention, the thus produced fiber arrangement will be fixed at least in sections on the support material, in which case a sewing operation can, for example, he used here, by which individual areas of the fiber arrangement can be fixed on the support material or reinforcing structures can be integrated in the fiber arrangement. The reinforcing structures will positively influence the subsequent forming operation in the process that follows.

In a next step, the thus produced fiber arrangement with the support material will then be provided for a subsequent process, thus, for example, is fed directly to a thermal forming operation or is intermediately stored in a stacking area disposed on the input side of a forming station. The support material, which may be a reasonably priced fiber glass mat or the like, facilitates the handling of the fiber preform in clamping devices, tensioning frames, blank holders and the like, and may remain in the fiber preform for the subsequent forming operation and, during the further processing of the fiber preform to the fib composite component, can support the subsequent processes, and improve the strength, stiffness and protection against corrosion in the component.

According to a further embodiment, it is provided that the making available of the blank includes the act of cutting the blank out of a fiber material as well as the immediately following arranging of the blank on the support material and the act of intermediately storing the cut-out blank in a template area before the arrangement of the blank on the support material.

According to the method of the invention, the support material may be provided, for example, in the form of a web on a roller, out of which a blank of the support material is then formed by a cutting portal and is then fed to a transfer portal arranged following t e cutting portal. It is also contemplated to keep already prefabricated blanks available in a template area of the transfer portal and then deposit them by an automated handling device on the transfer portal. In a similar manner, at least one blank of a fiber material can be formed by the cutting portal from a semi-finished product storage device wherein the semi-finished product is fed from the storage device to the cutting portal, the cutting portal producing a blank corresponding to form requirements, which were determined, for example, by means of a nesting program or a finite element computation, from the material web originating from the semi-finished product device, and then arranging it without an intermediate storage step directly on the support material. Also, several devices for the storage of fiber material semi-finished product may be disposed on the input side of the single cutter or multiple cutter of the cutting portal, from which semi-finished product can be removed and can be fed to the cutting portal for producing blanks. These blanks can then immediately be applied by the automated handling device in the form of a robot or the like to the support material blank and/or blanks already arranged thereon or can be intermediately stored before the arrangement by the automated handling device.

The angular orientation of the course of the fibers of the blank or of the blanks of fiber material after their production by the cutting portal is not relevant in this case because the alignment of the blank according to the load path before the application to the support material and/or to a blank already applied thereto is carried out corresponding to, for example, the finite element computation, thus, in general, is carried out in a predefined mariner by the automated handling device. In this manner, blanks from different semi-finished product storage devices, which are disposed on the input side of the cutting portals and whose fiber materials have different material characteristics in the form of, for example, knitted, stitched, layered, woven or crocheted characteristics, may also be integrated in the automated process for producing a fiber preform.

According to a further development, the method according to the invention also provides that at least one additional blank is arranged on a blank arranged on the support material while causing, at least in sections, an overlapping of the additional blank on the arranged blank. The additional blank is arranged in front of the arrangement corresponding to the direction of the loading of the blank in the fiber composite component, being aligned by means of the automated handling device, and thus positioned and rotated according to the load path.

In this manner, at least one blank with a unidirectional fiber course and/or multidirectional fiber course can be arranged on a blank already applied to the support material; thus, also a multi-layer fiber preform with differently dimensioned blanks can be provided in an automated manner. This is done so that, in contrast to the known methods, a fiber preform is created in an automated manner which has a multi-layered, i.e. reinforced construction, only in areas that are relevant with respect to the load, so that also the total mass of the resulting fiber preform and thereby the total mass of the fiber composite component can be reduced and a clear saving of material of semi-fished fiber product and a gain of light-weight potential in the future component can be achieved.

According to a further development, the invention also provides that inserts in the form of patches or TFP structures or the like and/or shaping structures, for example, in the form of resin foils or thermoplastic foils or blanks thereof, are integrated in the fiber preform. Thus, in addition to the fiber base materials, special materials are also integrated in the layer construction, which are inserted by the automated handling device into the layer construction in a predefined positioned and rotated manner. In this fashion, blanks with overlapping areas can also be arranged on one another, and intended cavities or areas with slanted overlapping regions of the blanks with tapered overlaps, in the case of which the layers overlap in sections, and/or angular changes of the load-absorbing fiber structures, are caused according to the load path.

It is also provided according to a further development of the invention that predefined areas of a construction consisting of support material and at least one blank are fixed to one another in areas in, for example, an intermediate storage area arranged on the output side of the automated handling device and an intermediate storage device for preforms disposed on the input side of the forming station. The areas can be sewn together, for example, be means of a fiber, whereby also targeted reinforcing structures can be integrated during the sewing operation in the layer construction, and support the future thermal forming operation in a targeted manner and avoid the formation of wrinkles or faults. By means of the sewing-together, the future finished component can also be locally reinforced mechanically, its structure can be fixed in the forming process, and the directly deposited structures can be fixed in a targeted manner for the injection process, and a better infiltration can be achieved in the direction of the thickness and in the direction of the plane.

According to a further development of the invention, it is also provided that a two-dimensional reinforcing structure is arranged via directly depositing a carbon fiber roving on a construction of the support material and/or at least one blank. The reinforcing structure can he applied according to the load path of the fiber composite component in the direction of the main load of the fiber composite component or at an angle deviating from a 0° orientation, which had been determined ahead of time as an angle relative to the main load axis.

Finally, the invention also provides that the support material, by way of which tension forces are introduced into the fiber preform, which stabilize the shaping, will remain on the preform during the subsequent process following the production of the fiber preform, thus, for example, during the entire handling phase up to and during the thermal formation operation.

The method according to the invention makes it possible that different surface grammages can he integrated in the layer construction of the preform. For forming the preform, the semi-finished textile product does not have to be present in the layer orientation that is correct for the integration in the preform with respect to its fiber course, because the alignment of the blank according to the load path is carried out by the automated handling device according to functional guidelines of the stack. In this manner, a mixing of blanks from fiber material semi-finished products is possible in the layer construction because the automated handling device picks up the separate individual layer blanks and applies them to the support material and/or individual layer blanks already situated there according to functional guidelines according to the load path and, in the process, can also integrate special materials in the layer construction. In this case, defined overlapping areas can be caused between individual layer blanks. The formation of cavities in the layer construction is also possible; as is the causing of predefined tapered layer laps and angular changes in the course of the fibers. Shaping structures in the form of resin foils, thermoplastic foils or the like can also be integrated in the layer construction.

A preform produced in this manner may be fed directly to a thermal forming process on the output side or may, for example, also be intermediately stored before the forming operation, in order to, for example, await dwell times required for the course of the thermal process.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic representation of a production device with a template area having several different fiber material semi-finished products for producing a fiber preform.

FIG. 2 is a view of a schematic construction of a production line for implementing the method according to the invention.

FIG. 3 is a view similar to FIG. 2 for explaining the integration of a reinforcing structure by direct fiber depositing.

FIG. 4 is a top view from an upper area of an A-pillar and of the roof frame of a fiber preform arranged on a section of a support material.

FIG. 5 is a top view similar to FIG. 4 which shows the application of UD fibers as the reinforcing structure.

FIG. 6 is a top view similar to FIG. 4 which shows the application of blanks with 45 fibers as the reinforcing structure.

FIG. 7 is a top view similar to FIG. 6 which shows the application of blanks with a fibers as the reinforcing structure.

### DETAILED DESCRIPTION OF THE DRAWINGS

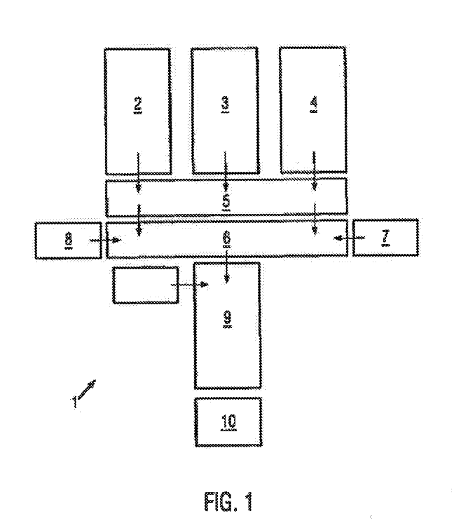

FIG. 1 illustrates a schematic overview outline of a production device or forming system for producing a fiber preform according to an exemplary method of the invention.

In the illustrated example, three different semi-finished fiber material products 2, 3, 4 with, for example, different surface grammages are arranged in a template area 1. Although only three semi-finished products are illustrated in the example shown, the number of semi-finished products can be increased depending on the use requirements.

The semi-finished products 2, 3, and 4 are fed to a common cutting portal 5, by which earlier-defined blank shapes were produced, for example, by use of a nesting program and a finite element computation. These blank shapes are optimized for the corresponding use case.

In this case, the angle of the textile semi-finished product is not relevant because each fiber angle can be produced according to the load path in the transfer portal 6 on the output side, in that the respective blank is correspondingly positioned and rotated by an automated handling device arranged in the transfer portal 6.

The transfer portal 6 is also capable of taking special materials in the form of, for example, patches or inserts form storage devices 7. 8 and feeding them to the layer construction, In this manner, a layer construction for a fiber arrangement is created which will be illustrated in detail in the following figures and which is then fixed on the support material 11 in a fixing unit 9 on the output side of the transfer portal 6 and, after a trimming, is fed to a de-stacking area 10 on the output side.

Instead of feeding the fiber preforms to the de-stacking area 10, which is disposed on the input side of a thermal forming station (not shown in detail), it is also contemplated to immediately feed the thus produced fiber preforms to the forming station for the thermal forming. This depends, for example, on the processing capacity of the forming station or required dwell times of the fiber preform before the thermal forming operation is carried out.

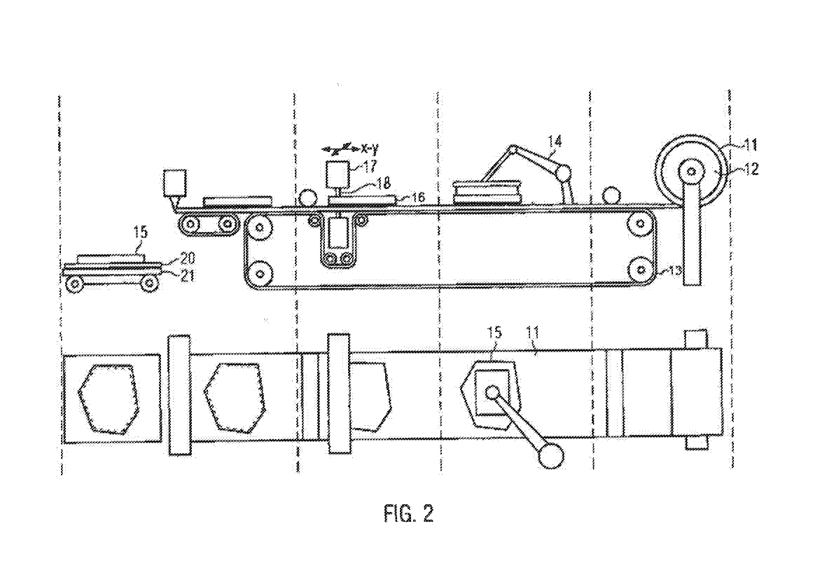

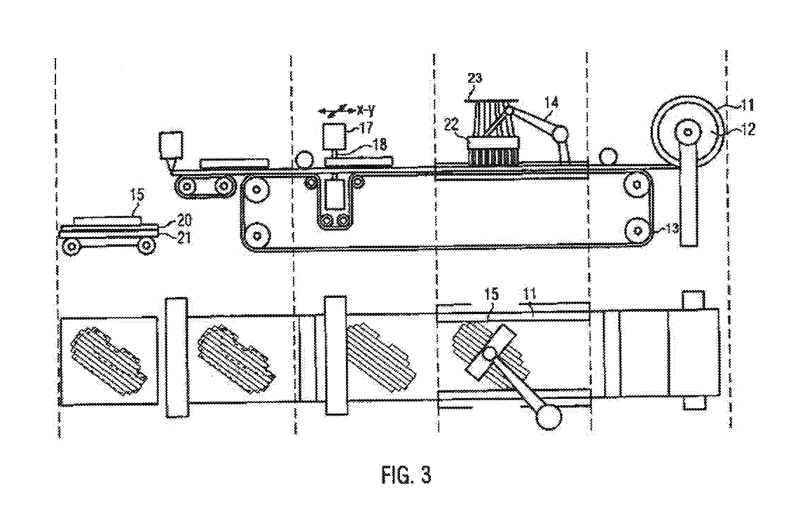

FIGS. 2 and 3 are schematic views of production lines for implementing the method according to the invention.

In a first section, a support material 11 is provided in the form of fiber glass support material arranged on a roller 12, which support material 11 is conveyed via a conveyor belt 13 in the direction of an automated handling device in the form of a robot 14. In the illustrated embodiment, the robot 14 takes a blank 15, from a template area with already produced blanks made of fiber materials, and positions the blank 15 on the support material such that the course of the fibers of the blank 15 is present for absorbing forces from the loading of the fiber composite component according to the load path.

In the case of a first layer of the layer construction, this may be a blank in the 0° angle orientation. in the case of the first layer, several blanks 15 with different surface grammages of textile semi-finished products can also already be processed.

Although only one blank 15 is illustrated in FIG. 2, the robot 14 can also arrange several blanks 15 with different angle arrangements of the fiber course of the individual blanks 15 with respect to one another on the support material 11, so that, in the case of several blanks arranged over one another, at least in sections, areas of the fiber preform are obtained that have different material thicknesses according to the load path, so that fiber material is present with a different material thickness only at points relevant to the load but not, for example, in areas of the future finished fiber composite component that are outside the main load direction. As a result unnecessary accumulations of fiber material can be avoided and material is thereby saved, on the one hand, and, on the other hand, a weight reduction of the finished fiber composite component can he achieved.

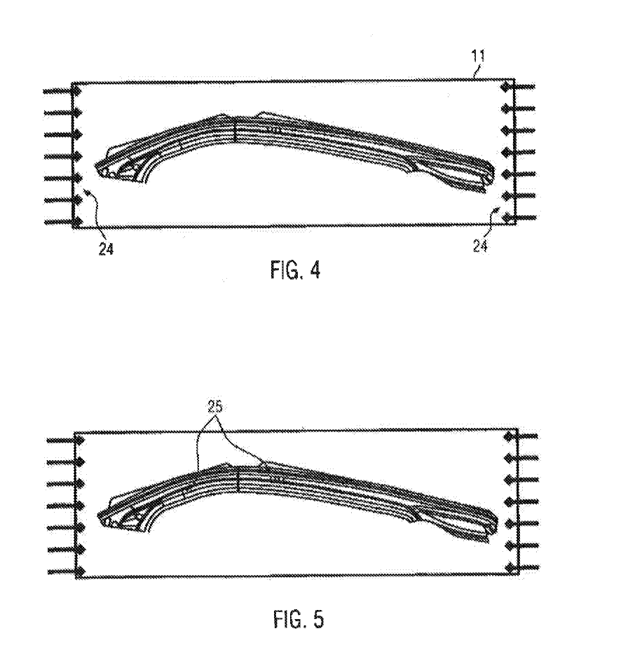

After a layer construction 16 with several blanks 15 (visible in greater detail in FIGS. 4 to 7) has been set up by the robot 14, the layer construction with the support material 11 is fed to a next section of the production line by way of the conveyor belt 13, in which a CNC portal sewing machine 17 in a two-dimensional manner produces fixing seams by way of a sewing head 18 and fixes the layer construction 16 or the blanks 15 on the support material 11.

Subsequently, the support material 11 with the blanks 15 fixed thereon will leave the section of the production line with the portal sewing machine 17 and be fed by way of the conveyor belt 13 to a traversing separating system in the form of, for example, a cutting device operating by lasers. The cutting device will cut a section 20 visible in the drawing from the fiberglass support material 11 present in a web shape and a resulting fiber preform with the support material was produced for the de-stacking on a schematically illustrated storage device 21.

FIG. 3 is a schematic representation of a production line, which basically corresponds to the production line illustrated in FIG. 2 and in which an additional functionality was integrated. This additional functionality is exhibited in the area in which the robot 14 is arranged for the automated positioning and rotating of the blanks 15.

In addition to the automated positioning and rotating of the blanks on the support material, which meet the load path requirements, the robot 14 carries out the additional function of the formation of a reinforcing structure by way of a direct fiber deposit on the blanks 15, For this purpose, fiber material in the form of fiber cables is fed to a multiple laying head 22 of the robot 14 by way of a roving feed 23. The fiber material is applied by the multiple laying head 22 to the layer construction for forming a reinforcing structure.

The further operating steps of the production line illustrated in FIG. 3 will then again correspond to that according to FIG. 2.

FIG. 4 is atop view of a fiber preform that is arranged on a section of a support material 11 from the upper area of an A-pillar and of the roof frame of a vehicle not shown in detail.

The drawing is simultaneously used for explaining that, according to the method of the invention, it is also possible to provide a section of the support material 11, for example, of a fiberglass material, ahead of time, to which then, by means of the automated handling device 14, blanks 15 made of fiber materials can be applied, specifically such that the blanks 15 are arranged in the respective section of the preform in a positioned and rotated manner according to the load path. The drawing also shows that the support material 11 is held laterally by tensioning devices in the form of clamping devices 24 and can be kept under tension. It is also possible to fix the support material 11 by means of a tensioning frame, which is not shown in detail, at least on the short face sides of the support material 11, instead of using the clamping devices 24.

An integration preform corresponding to the desired shape of the fiber composite component may be provided in the above-described manner by the application of several blanks 15 made of fiber materials to the support material 11.

Furthermore, a reinforcing structure may also be applied to the integration preform by the application of UD (unidirectional) fibers extending in direction of the flow of force, which UD fibers are applied by means of a corresponding laying head by the robot 14 in the form of a strand 25 to at least one already laid blank 15.

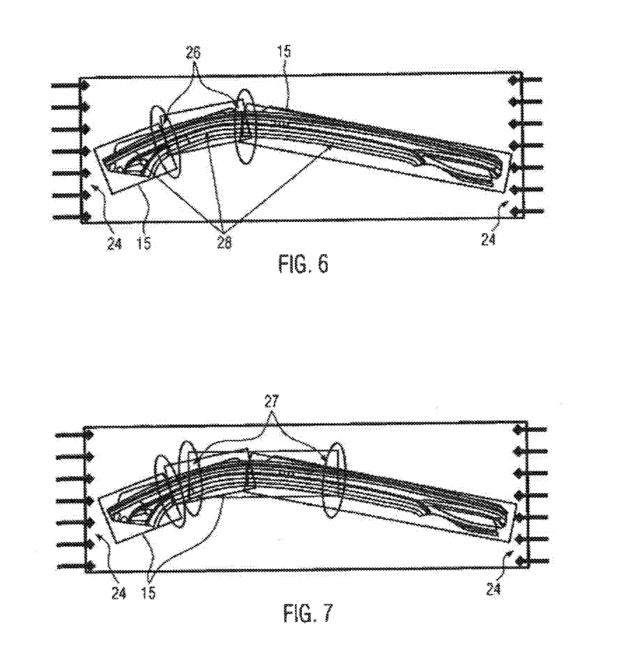

FIG. 6 further illustrates the possibility of increasing the torsional stiffness of the integration preform by means of the method according to the invention, in that patches 28 of 45 fiber material, which may be present in the overlapping area 26 between different blanks 15 with straight or slanted cut edges, are applied by way of the automated handling device 14.

Finally, FIG. 7 also shows the construction of reinforcing structures at the integration preform by the method of the invention on local overlapping areas 27. The reinforcing structures are formed by applying blanks 15 with 0° material to blanks already laid for forming the fiber arrangement.

The fiber preform produced in such a manner can then be transferred directly to a forming station for the thermal treatment or may be arranged in an intermediate storage area, as explained above.

The method according to the invention makes it possible to apply reinforcing structures made of carbon fibers to the support material close to the end contour relative to the component geometry of the fiber composite component in an automated manner. The waste of expensive carbon fiber material is reduced.

The support material participates in the process steps following the production of the fiber preform and facilitates the handling and the storage of the fiber preform.

By way of the support material, the retention forces required for the forming operation can be forwarded to the sewed connection d the reinforcing structure. This makes it possible to avoid the formation of wrinkles and faults and increases the quality of the preform.

In addition to introducing reinforcing structures into the fiber preform by the application of blanks and/or patches, it also becomes possible to spread open a carbon fiber roving to form a fiber band and lay it directly on the structure to be reinforced. As a result, a significant saving of material is achieved and waste is reduced, compared to the formation of a stack in which the reinforcing structures are constructed in a full-face fashion.

The reinforcing structures may be integrated in the fiber arrangement according to the load path. This saves material again, and the finished fiber composite component can absorb higher loads while the weight is reduced simultaneously.

In the course of fixing the blanks on one another and on the support material, reinforcing structures may also be integrated in the fiber arrangement which avoid the formation of wrinkles during the forming operation, whereby a better forming result can be achieved.

The fixing in the form of a sewing-together also increases the loading capacity of the laminate in the thickness direction, whereby higher loads can be absorbed locally, particularly at joint locations.

The method according to the invention also provides that the layer construction is not limited with respect to the number of individual layers, because cutting does not take place through all full-face individual layers at once, as occurs during the formation of a stack according to prior known methods.

The method according to the invention also permits the feeding of special materials in the form of inserts or the like. The angle orientation of the blank is not dependent on the angle orientation of the starting material, thus of the semi-finished product, because the individual blanks can each be produced separately.

### List of Reference Numbers

1 Template area
2 Semi-finished fiber material product
3 Semi-finished fiber material product
4 Semi-finished fiber material product
5 Cutting portal
6 Transfer portal
7 Storage device
8 Storage device
9 Fixing unit
10 De-stacking area
11 Support material
12 Roller
13 Conveyor belt
14 Robot
15 Blank
16 Layer construction
17 Portal sewing machine
18 Sewing head
19 Cutting device
20 Section
21 Storage device
22 Laying head
23 Roving feed
24 Clamping device
25 Strand
26 Overlapping area
27 Overlapping area
28 Patches

The foregoing disclosure has been set forth merely to illustrate the invention and is not intended to he limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of producing a fiber preform for a fiber composite component, wherein a fiber arrangement is placed on a support material and the support material is held by a clamping device during a forming process, the method comprising the acts of:
providing at least one blank from a fiber material;
aligning, via an automated handling device, the blank corresponding to a direction of loading of the blank in the fiber composite component;
fixing the blank on the support material; and
providing the support material with the fixed blank for a subsequent process.

2. The method according to claim 1, wherein the act of providing the at least one blank further comprises the act of:
cutting out the blank from a fiber material.

3. The method according to claim 2, further comprising the act of arranging the blank on the support material immediately following the cutting out of the blank from the fiber material.

4. The method according to claim 2, further comprising the act of intermediately storing the blank cut out of the fiber material in a template ea before an arranging of the blank on the support material.

5. The method according to claim 3, further comprising the acts of:
arranging at least one additional blank on the blank arranged on the support material so as to overlap, at least in sections, wherein the additional blank is arranged on the blank before aligning the blank corresponding to the direction of the loading of the blank in the fiber composite component.

6. The method according to claim 4, further comprising the acts of:
arranging at least one additional blank on the blank arranged on the support material so as to overlap, at least in sections, wherein the additional blank is arranged on the blank before aligning the blank corresponding to the direction of the loading of the blank in the fiber composite component.

7. The method according to claim 1, wherein at least one further blank having a unidirectional fiber course and/or a multidirectional fiber course is arranged on the blank arranged on the support material.

8. The method according to claim 1, further comprising the act of integrating inserts and/or shaping structures into the fiber preform.

9. The method according to claim 1, wherein predefined areas of a construction of the support material and the at least one blank are sewn together to fix the blank on the support material.

10. The method according to claim 1, wherein a two-dimensional reinforcing structure is formed by directly depositing a carbon fiber roving on a construction of the support material and the at least one blank.

11. The method according to claim 10, wherein the reinforcing structure is oriented in the direction of a main loading direction of the fiber composite component on the construction.

12. The method according to claim 1, wherein the support material remains on the fiber preform during a shaping operation that follows the production of the fiber preform.
